(19) United States
(12) Patent Application Publication
(10) Pub. No.: US 2011/0094645 A1
(43) Pub. Date: Apr. 28, 2011

(54) Innerliners for Off-Road, Farm, Large Truck and Aircraft Tires

(76) Inventors: Michael Brendan Rodgers, Seabrook, TX (US); Bharat B. Sharma, Bangalore (IN); Nitin K. Tambe, Houston, TX (US); Weiqing Weng, Houston, TX (US)

(21) Appl. No.: 12/605,910

(22) Filed: Oct. 26, 2009

(51) Int. Cl. B60C 5/12

(52) U.S. Cl. 152/510

(57) ABSTRACT

Disclosed is a pneumatic tire comprising an innerliner comprising a functionalized poly(isobutylene-co-p-methylstyrene) elastomer, at least one layered filler; and less than 8 phr of at least one processing aid; wherein the innerliner possesses a permeation coefficient of less than 200 mm·cm³/m²·day at 40° C.; and wherein the tire is selected from truck tires, airplane tires, off-the-road tires and farm tractor tires. In a preferred embodiment, the tire is formed by a process of contacting the functionalized poly(isobutylene-co-p-methylstyrene) elastomer, at least one layered filler, and at least one solvent to form an nanocomposite composition; and combining the nanocomposite composition with the at least one processing aid and a curative composition to form the innerliner, then forming the tire comprising the innerliner.

### FIELD OF THE INVENTION

The present disclosure relates to isobutylene-based elastomer compositions with clays for use as innerliners for aircraft, heavy truck, off-the-road and farm tires, and in particular to nanocomposite innerliners made of a solution blend of exfoliated clays and poly(isobutylene-co-p-methylstyrene) elastomer.

### BACKGROUND

Pneumatic tires fall into one of seven broad categories which include passenger vehicle tires, light truck tires, commercial medium and heavy truck tires, agricultural or farm tires, off-the-road tires (“OTR”), and aircraft tires. Each of these tire lines must meet different performance criteria. In particular, tires used for heavy trucks, farm tires, OTR and aircraft tires must have exceptional durability due to heavy loads and high temperatures that are generated within the tires due to speed and/or load. Further, tires that fall into these categories often need to be long-lasting without the need for service.

Aircraft Tires. Aircraft tires, as in the case of other tire lines, can be divided into sub-categories depending on the mission profile of the tire. In this case, aircraft tires fall into one of four groups: (i) general utility aircraft tires which would include business jets, (ii) commercial aircraft tires, (iii) military aircraft tires, and (iv) rotary aircraft tires. Four major parameters govern an aircraft tire's performance: centrifugal forces acting on the tire during take-off and landing, heat build up, durability and retreadability, and inflation pressure maintenance.

At 100 mph the centrifugal force acting on 1 ounce of tire tread compound is 33 lbs. For an 8 lb tread on a tire this is 4200 lbs. At 200 mph, the centrifugal forces increase to 16,600 lbs. Reduction in tire weight, with no loss in load carrying capability or tire load rating will lead to a reduction in these centrifugal forces. High tire operating temperatures lead to a reduction in the tensile strength of the ply fabric reinforcements. Increase in tire operating temperature from 30° C. to 300° C. can lead to a drop in tensile strength of up to 40%. Cumulative heat history in a tire, due to multiple take-offs and landings, also leads to this reduction in reinforcement tensile strength. Thus, the lower the operating temperature of a tire, the more durable it may be. The more durable the materials used in the tire construction, the better the performance of the tire and the more retreadable it may be.

Farm Tires. Fanning is undergoing a variety of trends which includes formation of larger, and fewer, farms. There is a growing emphasis on increase in productivity, addressing environmental challenges, and introduction of biotechnology and computer tools. As part of this trend, equipment such as tractors and implements are being designed for higher speeds, and increased horsepower. Tire radialization is occurring with long term durability and damage resistance requirements.

Farm and related tires used in agricultural service can be classified into three groups, (i) steer or front tractor tires, (ii) tractor rear axle drive tires, and (iii) implement tires. Front steering axle tires on a tractor and implement tires have traditionally tended to be of a bias construction and contain tubes. Rear axle drive tires are more frequently of a radial construction and may or may not be tubeless. In many newer tractor designs, radial tires designed for rear axles may also be mounted on the steering axle for maneuverability.

Improved tire innerliner performance will address and enable improvements in a number of these performance parameters. The inventors have found technology here most suited for radial tires, typically found in the rear drive position of tractors, designated R1 through to R4, and would be applicable to tires of any size, but especially to those ranging in size from 7.5R16 and 200/70R16 to 320190R50 and wide base tires such as 710/70R38 and 900150R42.

Off-the-Road (“OTR”) Tires. OTR tires are divided into various applications groups. There are five categories of OTR tires, (i) tires for graders (e.g. used for highway construction), (ii) tires for dozers, (iii) mining tires, (iv) truck and haulage vehicle tires, and (v) special purpose tires such as those for cranes in docks and back-hoes. Tires are available in both radial and bias constructions with radial tire sizes, which for the purpose of this discussion, will range from 14.00R24 up to 40.00R57. Tube type tires are more common, though tubeless radials are available. Radial tires like those used in highway trucks, have a steel ply construction.

OTR tires are not normally retreaded so achievement of a full worn out condition is important for the end user. Correct inflation pressure is required to maximize wear performance, minimize irregular wear, maintain traction or grip performance (avoid skidding, and spinning, which can detrimentally effect wear), and prevent casing deterioration due to excessive flexing. Poor chip-chunk-cut resistance will also have a detrimental effect on wear.

Butyl rubber (“IIR”), chlorobutyl (“CIIR”), bromobutyl (“BIIR”), and isobutylene p-methylstyrene copolymer (“BIMS”) are used by tire companies to blend with other compounding ingredients such as carbon black for use as the tire innerliner. Halobutyl rubber enables the tire to maintain air pressure. Tire companies are searching for improvement in halobutyl innerliner performance. The inventors have found that the various performance parameters to which farm, OTR, heavy truck and aircraft tires must perform shows that isobutylene based polymer-nanoclay nanocomposites offer the most potential for tire innerliner performance improvement. Such composite compounds can be mixed using internal mixers such as a Banbury, extruded, or calendered on existing tire factory equipment, innerliner components assembled into tires using existing building machines, and tires cured using existing presses. However, increased air impermeability can be achieved by manipulating how the nanocomposite is produced.

Publications that describe blends of elastomers and exfoliated clays include US 2004-0132894, US 2004-0194863, US 2005-0027057, US 2006-0235128, US 2007-0015853, US 2007-0219304, US 2009-0050251, US 2009-0005493, WO 2008-118174, and K.-B. Yoon et al. in “Modification of montmorillonite with oligomeric amine derivatives for polymer nanocomposite preparation” in 38 APPLIED CLAY SCIENCE 1-8 (2007).

### SUMMARY

Described in one embodiment is a pneumatic tire comprising an innerliner comprising a functionalized poly(isobutylene-co-p-methylstyrene) elastomer, at least one layered filler; and less than 8 or 7 or 6 or 5 or 4 phr (or within the range from 0.1 or 0.5 or 1 or 2 or 3 or 4 to 6 or 8 phr) of at least one processing aid; wherein the innerliner possesses a permeation coefficient of less than 200 or 180 or 160 mm·cm³/m²·day at 40° C.; and wherein the tire is selected from truck tires, airplane tires, off-road tires and farm tractor tires. In a particular embodiment, the layered filler also comprises an exfoliating agent.

In certain embodiments, the tire is formed by a process of contacting the functionalized poly(isobutylene-co-p-methylstyrene) elastomer, at least one layered filler, and at least one solvent to form a nanocomposite composition; and combining the nanocomposite composition with less than 8 or 7 or 6 or 5 or 4 phr of at least one processing aid and a curative composition to form an innerliner composition, the tire formed to comprise an innerliner formed from the innerliner composition. In certain embodiments, the solvent is removed from the nanocomposite composition prior to combining with the at least one processing aid and curative composition.

In certain embodiments, the tire is produced by melt blending all of the components to form an innerliner composition, the tire formed to comprise an innerliner formed from the innerliner composition.

In certain embodiments, the green tire is of a size that requires a cure time of greater than 30 minutes or 1 hour or 5 hours or 10 hours or 16 hours.

In certain embodiments, the tire has an Endurance value of at least 90 or 100 hours-to-failure.

In certain embodiments, the tire has a Durability value of at least 240 or 250 hours-to-failure.

Also, in certain embodiments, the reversion resistance of the tire does not decline by more than 5% from its maximum value at Tₘₐₓ₋₁₀ at 180° C.

The various descriptive elements and numerical ranges disclosed herein can be combined with other descriptive elements and numerical ranges to describe preferred embodiments of the compositions, innerliners, tires comprising innerliners and processes to make such described herein; further, any upper numerical limit of an element can be combined with any lower numerical limit of the same element to describe preferred embodiments. In this regard, the phrase “within the range from X to Y” is intended to include within that range the “X” and “Y” values.

Unless otherwise noted, values of “parts per hundred rubber”, or “phr” are significant to the hundredths decimal place. Thus, the expressions “1 phr” and “60 phr” are equivalent to 1.00 phr and 60.00 phr, respectively.

If an amount of a component is stated, that amount is understood to be an aggregate amount if two or more different species of that component are present together.

### BRIEF DESCRIPTION OF THE DRAWINGS

FIG. 1 is a bar graph comparing the permeation coefficient (m·cm³/[m²-day] at 40° C.) of various nanocomposite formulations made by the “melt” process and the “solu” (“solution”) process; and

FIG. 2 is a graphical representation of the torque value applied to a nanocomposite sample as a function of time for various comparative and inventive nanocomposite formulations, the relationship representing the compositions' reversion resistance.

### DETAILED DESCRIPTION

### Introduction

Described herein are large pneumatic tires comprising innerliners with improved gas permeability and reversion resistance. In particular, the inventors have found particular elastomeric compositions are useful in large tires such as truck tires, airplane tires, OTR tires and farm tractor tires. The improved tires are characterized in part by having a lower level of processing aid, such as naphthenic or paraffinic oils, which improves the air barrier properties. Yet, the tires that incorporate these innerliners have good cure stability, or “reversion resistance.” What is disclosed can be described in one embodiment as a pneumatic tire comprising an innerliner that includes at least a functionalized poly(isobutylene-co-p-methylstyrene) elastomer, a layered filler; and less than 8 phr of a processing aid (e.g., naphthenic or paraffinic oils). Desirably, the innerliner possesses a permeation coefficient of less than 200 mm·cm³/m²-day at 40° C. The nanocomposite can be made by any technique known for making elastomeric nanocomposites, including the solution process described herein, and conventional melt mixing processes.

As used herein, a “nanocomposite” (or “nanocomposite composition”) is a blend of an elastomer with one or more layered fillers, and in a particular embodiment, a layered filler that has been treated or “exfoliated” with an exfoliating agent as described herein.

The nanocomposite may be combined with other materials known in the art (additional oils, curatives, fillers, etc.) to produce an innerliner composition. This “green” (uncured) composition can be formed into a tire and then cured by standard techniques to form a finished truck, airplane, OTR or farm tire, typically those having a diameter greater than 16 or 17 inches or more.

### Elastomeric Component

The nanocomposites described herein comprise at least one elastomer along with other components described and claimed herein. In a particular embodiment, the elastomer is an interpolymer. The interpolymer may be random elastomeric copolymers of a C₄ to C₇ isomonoolefins, such as isobutylene and a para-alkylstyrene comonomer, such as para-methylstyrene, containing at least 80%, more alternatively at least 90% by weight of the para-isomer and optionally include functionalized interpolymers wherein at least one or more of the alkyl substituents groups present in the styrene monomer units contain benzylic halogen or some other functional group. These may be referred to as functionalized poly(isobutylene-co-p-methylstyrene) (“FIMS”). In another embodiment, the interpolymer may be a random elastomeric copolymer of ethylene or a C₃ to C₆ α-olefin and a para-alkylstyrene comonomer, such as para-methylstyrene containing at least 80%, alternatively at least 90% by weight of the para-isomer and optionally include functionalized interpolymers wherein at least one or more of the alkyl substituents groups present in the styrene monomer units contain benzylic halogen or some other functional group. Exemplary materials may be characterized as interpolymers containing the following monomer units randomly spaced along the polymer chain:

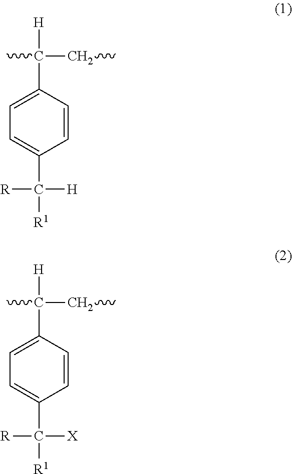

wherein R and R¹ are independently hydrogen, lower alkyl, such as a C₁ to C₇ alkyl and primary or secondary alkyl halides and X is a functional group such as halogen. In a particular embodiment, R and R¹ are each hydrogen. In certain embodiments, the amount of functionalized structure (2) is from 0.1 or 0.4 to 1 or 5 mol %.

The functional group X may be halogen or some other functional group which may be incorporated by nucleophilic substitution of benzylic halogen with other groups such as carboxylic acids; carboxy salts; carboxy esters, amides and imides; hydroxy; alkoxide; phenoxide; thiolate; thioether; xanthate; cyanide; cyanate; amino and mixtures thereof. These functionalized isomonoolefin copolymers, their method of preparation, methods of functionalization, and cure are more particularly disclosed in U.S. Pat. No. 5,162,445, incorporated herein by reference. In another embodiment, the functionality is selected such that it can react or form polar bonds with functional groups present in the matrix polymer of a desirable composition, for example, acid, amino or hydroxyl functional groups, when the polymer components are mixed at high temperatures. In a particular embodiment, the elastomer is halogenated poly(isobutylene-co-p-methylstyrene), and in a more particular embodiment, is brominated poly(isobutylene-co-p-methylstyrene) (“BIMS”).

In certain embodiments, functionalized materials are elastomeric random interpolymers of isobutylene and para-methylstyrene containing from 0.5 to 20 mol % para-methylstyrene wherein up to 60 or 50 or 20 or 10 mol % of the methyl substituent groups present on the benzyl ring contain a bromine or chlorine atom, such as a bromine atom (para-(bromomethylstyrene)), as well as acid or ester functionalized versions thereof. Expressed

In certain embodiments, these functionalized interpolymers have a substantially homogeneous compositional distribution such that at least 95% by weight of the polymer has a para-alkylstyrene content within 10% of the average para-alkylstyrene content of the polymer. Exemplary interpolymers are characterized by a narrow molecular weight distribution (Mw/Mn) of less than 5, alternatively less than 2.5, an exemplary viscosity average molecular weight in the range of from 200,000 up to 2,000,000 and an exemplary number average molecular weight in the range of from 25,000 to 750,000 as determined by gel permeation chromatography. In certain embodiments, the functionalized interpolymers have a Mooney Viscosity (ML1+4) of less than 50 or 45 or 40.

The interpolymers may be prepared by a slurry polymerization, typically in a diluent comprising a halogenated hydrocarbon(s) such as a chlorinated hydrocarbon and/or a fluorinated hydrocarbon including mixtures thereof, of the monomer mixture using a Lewis acid catalyst, followed by halogenation, preferably bromination, in solution in the presence of halogen and a radical initiator such as heat and/or light and/or a chemical initiator and, optionally, followed by electrophilic substitution of bromine with a different functional moiety.

The polymer component of the nanocomposites described herein may comprise one or more secondary elastomers or may comprise any combination of at least two or more of the secondary elastomers. The secondary elastomer may comprise any one or more of natural rubber, polyisoprene rubber, poly(styrene-co-butadiene) rubber (SBR), polybutadiene rubber (BR), poly(isoprene-co-butadiene) rubber (IBR), styrene-isoprene-butadiene rubber (SIBR), ethylene-propylene rubber (EPM), ethylene-propylene-diene rubber (EPDM), polysulfide, nitrile rubber, propylene oxide polymers, star-branched butyl rubber and halogenated star-branched butyl rubber, brominated butyl rubber, chlorinated butyl rubber, star-branched polyisobutylene rubber, star-branched brominated butyl (polyisobutylene/isoprene copolymer) rubber; poly(isobutylene-co-p-methylstyrene) and halogenated poly(isobutylene-co-p-methylstyrene), such as, for example, terpolymers of isobutylene derived units, p-methylstyrene derived units, and p-bromomethylstyrene derived units, and mixtures thereof. If present, such secondary elastomer or elastomer mixture is present within the range of from 2 or 4 or 10 to 20 or 30 or 60 or 80 phr.

### Clay—Layered Filler

Nanocomposites may include at least one elastomer rubber as described above and at least one layered filler. Examples of the layered filler are certain clays (“layered fillers”), optionally, treated or pre-treated with organic molecules, particularly, exfoliating agents. In certain embodiments, the layered filler generally comprise particles containing a plurality of silicate platelets having a thickness of 8-12 Å tightly bound together at interlayer spacings of 4 Å or less, and contain exchangeable cations such as Na⁺, Ca⁺², K⁺ or Mg⁺² present at the interlayer surfaces.

Layered fillers include natural or synthetic phyllosilicates, such as smectic clays such as montmorillonite, nontronite, beidellite, volkonskoite, laponite, hectorite, saponite, sauconite, magadite, kenyaite, stevensite and the like, as well as vermiculite, halloysite, aluminate oxides, hydrotalcite, and combinations thereof. In certain embodiments, the layered filler has an aspect ratio of greater than 30 or 40 or 50 or 60, or within the range from 30 or 40 or 50 to 90 or 100 or 120 or 140.

The layered filler may be intercalated and exfoliated by treatment with organic molecules such or “exfoliating agents” capable of undergoing ion exchange reactions with the cations present at the interlayer surfaces of the layered silicate, termed herein as “exfoliating agents”. Suitable layered fillers include cationic exfoliating agents such as ammonium, alkylamines or alkylammonium (primary, secondary, tertiary and quaternary), phosphonium or sulfonium derivatives of aliphatic, aromatic or arylaliphatic amines, phosphines and sulfides. In certain embodiments, the exfoliating agent has a weight average molecular weight of less than 5000 or 2000 or 1000 or 800 or 500 or 400 amu (and within the range from 200 or 300 to 400 or 500 or 800 or 1000 or 2000 or 5000 amu). In certain embodiments, the exfoliating agent is present in the layered filler within the range from 5 or 10 or 15 or 20 to 40 or 45 or 50 or 55 or 60 wt %, based on the weight of exfoliating agent and clay. Stated as parts per hundred rubber, the exfoliating agent is present in the layered filler within the range of from 0.1 or 0.2 or 0.5 or 1 to 5 or 6 or 7 or 8 phr in the nanocomposite.

For example, amine compounds (or the corresponding ammonium ion) are those with the structure R²R³R⁴N (each “R” bound to the nitrogen), wherein R², R³, and R⁴ are C₁ to C₃₀ alkyls or alkenes in one embodiment, C₁ to C₂₀ alkyls or alkenes in another embodiment, which may be the same or different. In one embodiment, the exfoliating agent is a so-called long chain tertiary amine, wherein at least R² is a C₁₄ to C₂₀ alkyl or alkene.

In other embodiments, a class of layered fillers include those which can be covalently bonded to the interlayer surfaces. These include polysilanes of the structure —Si(R⁵)₂R⁶ where R⁵ is the same or different at each occurrence and is selected from alkyl, alkoxy or oxysilane and R⁶ is an organic radical compatible with the matrix polymer of the composite.

Other suitable layered fillers include protonated amino acids and salts thereof containing 2-30 carbon atoms such as 12-aminododecanoic acid, epsilon-caprolactam and like materials. Suitable exfoliating agents and processes for intercalating layered silicates are disclosed in U.S. Pat. No. 4,472,538, U.S. Pat. No. 4,810,734, U.S. Pat. No. 4,889,885 as well as WO 92-02582.

In an embodiment, the layered filler or additives are capable of reacting with the halogen sites of the halogenated elastomer to form complexes which help exfoliate the clay. In certain embodiments, the additives include all primary, secondary and tertiary amines and phosphines; alkyl and aryl sulfides and thiols; and their polyfunctional versions. Desirable additives include long-chain tertiary amines such as N,N-dimethyl-octadecylamine, N,N-dioctadecyl-methylamine, so called dihydrogenated tallowalkyl-methylamine and the like, and amine-terminated polytetrahydrofuran; long-chain thiol and thiosulfate compounds like hexamethylene sodium thiosulfate.

The layered filler may be added to the composition at any stage of production; for example, the additive may be added to the elastomer, followed by addition of the layered filler, or may be added to a combination of at least one elastomer and at least one layered filler; or the additive may be first blended with the layered filler, followed by addition of the elastomer in yet another embodiment.

In certain embodiments, treatment of the elastomer with the exfoliating agents described above results in intercalation or “exfoliation” of the layered platelets as a consequence of a reduction of the ionic forces holding the layers together and introduction of molecules between layers which serve to space the layers at distances of greater than 4 Å, alternatively greater than 9 Å. This separation allows the layered silicate to more readily sorb polymerizable monomer material and polymeric material between the layers and facilitates further delamination of the layers when the intercalate is shear mixed with matrix polymer material to provide a uniform dispersion of the exfoliated layers within the polymer matrix.

In certain embodiments, the layered filler are clays that have already been intercalated with alkyl ammonium or other exfoliating agents and are termed “exfoliated layered filler” herein. Commercial products are available as Cloisites produced by Southern Clay Products, Inc. in Gunsalas, Tex. For example, Cloisite Na⁺, Cloisite 30B, Cloisite 10A, Cloisite 25A, Cloisite 93A, Cloisite 20A, Cloisite 15A, and Cloisite 6A. They are also available as Somasif™ and Lucentite™ clays produced by CO-OP Chemical Co., LTD., Tokyo, Japan. For example, Somasif MAE, Somasif MEE, Somasif MPE, Somasif MTE, Somasif ME-100, Lucentite™ SPN, and Lucentite SWN.

The amount of exfoliated layered filler incorporated in the nanocomposites in accordance with certain embodiments is sufficient to develop an improvement in the mechanical properties or barrier properties of the nanocomposite, for example, tensile strength or oxygen permeability. Amounts generally will range from 0.5 to 10 wt % in one embodiment, and from 1 to 5 wt % in another embodiment, based on the polymer content of the nanocomposite. Expressed in parts per hundred rubber, the exfoliated layered filler is present in the nanocomposite within the range from 4 or 5 phr to 6 or 7 or 8 or 10 phr.

### Producing the Nanocomposite

The nanocomposites described herein may be produced by solution processes. In certain embodiments, the solution process may be included with in situ production of the nanocomposite composition. In an embodiment, the process may comprise contacting at least one elastomer and at least one layered filler, such as the layered filler as described above, in a solution comprising at least one solvent. This so-called “solvent” or “solution” method is described in US 2007-0219304. Methods and equipment for both lab and large-scale production, including batch and continuous processes, are well known in the art.

Suitable solvents include hydrocarbons such as alkanes, including C₄ to C₂₂ linear, cyclic, branched alkanes, alkenes, aromatics, and mixtures thereof. Examples include propane, isobutane, pentane, methycyclopentane, isohexane, 2-methylpentane, 3-methylpentane, 2-methylbutane, 2,2-dimethylbutane, 2,3-dimethylbutane, 2-methylhexane, 3-methylhexane, 3-ethylpentane, 2,2-dimethylpentane, 2,3-dimethylpentane, 2,4-dimethylpentane, 3,3-dimethylpentane, 2-methylheptane, 3-ethylhexane, 2,5-dimethylhexane, 2,24,-trimethylpentane, octane, heptane, butane, ethane, methane, nonane, decane, dodecane, undecane, hexane, methyl cyclohexane, cyclopropane, cyclobutane, cyclopentane, methylcyclopentane, 1,1-dimethylcycopentane, cis-1,2-dimethylcyclopentane, trans-1,2-dimethylcyclopentane, trans-1,3-dimethylcyclopentane, ethylcyclopentane, cyclohexane, methylcyclohexane, benzene, toluene, xylene, ortho-xylene, para-xylene, meta-xylene, and mixtures thereof.

In an embodiment, the solution comprises at least one hydrocarbon. In another embodiment, the solution consists essentially of at least one hydrocarbon. In yet another embodiment, the solution comprises or consists essentially of two or more hydrocarbons. In other embodiments, the solution may comprise at least one hexane, such as cyclohexane or mixtures of hexanes. Mixtures of hydrocarbons such as mixtures of hexanes are commonly available as lower grade commercial products.

In another embodiment, suitable solvents include one or more nitrated alkanes, including C₂ to C₂₂ nitrated linear, cyclic or branched alkanes. Nitrated alkanes include, but are not limited to nitromethane, nitroethane, nitropropane, nitrobutane, nitropentane, nitrohexane, nitroheptane, nitrooctane, nitrodecane, nitrononane, nitrododecane, nitroundecane, nitrocyclomethane, nitrocycloethane, nitrobenzene, and the di- and tri-nitro versions of the above, and mixtures thereof. Halogenated versions of all of the above may also be used such as chlorinated hydrocarbons, for example, methyl chloride, methylene chloride, ethyl chloride, propyl chloride, butyl chloride, chloroform, and mixtures thereof.

Hydrofluorocarbons may also be used as a solvent, for example, fluoromethane; difluoromethane; trifluoromethane; fluoroethane; 1,1-difluoroethane; 1,2-difluoroethane; 1,1,1-trifluoroethane; 1,1,2-trifluoroethane; 1,1,1,2-tetrafluoroethane; 1,1,2,2-tetrafluoroethane; 1,1,1,2,2-pentafluoroethane; 1-fluoropropane; 2-fluoropropane; 1,1-difluoropropane; 1,2-difluoropropane; 1,3-difluoropropane; 2,2-di fluoropropane; 1,1,1-trifluoropropane; 1,1,2-trifluoropropane; 1,1,3-trifluoropropane; 1,2,2-trifluoropropane; 1,2,3-trifluoropropane; 1,1,1,2-tetrafluoropropane; and mixtures thereof and variants of these solvents as is known in the art. In certain embodiments, unsaturated hydrofluorocarbons may also be used.

In another embodiment, suitable solvents include at least one oxygenate, including C₁ to C₂₂ alcohols, ketones, ethers, carboxylic acids, esters, and mixtures thereof.

In certain embodiments, a nanocomposite is produced by a process comprising contacting Solution A comprising a solvent comprising a hydrocarbon and at least one layered filler; Solution B comprising a solvent and at least one elastomer; and removing the solvents from the contact product of Solution A and Solution B to form a nanocomposite. In this and other embodiments, the layered filler may be a layered filler treated with exfoliating agents as described herein.

In yet another embodiment, a nanocomposite is produced by a process comprising contacting at least one elastomer and at least one layered filler in a solvent; and removing the solvent from the contact product to form a nanocomposite. Any number of solvents, and/or combination thereof, may be used. In lieu of, or in addition to this, the nanocomposite formed by contacting the elastomer and layered filler (with or without exfoliating agent) may be precipitated by the addition of desirable solvent, in particular, a polar solvent such as an alcohol.

In the embodiments described above, solvents may be present in the production of the nanocomposite composition from 30 to 99 wt %, alternatively from 40 to 99 wt %, alternatively from 50 to 99 wt %, alternatively from 60 to 99 wt %, alternatively from 70 to 99 wt %, alternatively from 80 to 99 wt %, alternatively from 90 to 99 wt %, alternatively from 95 to 99 wt %, based upon the total weight of the composition.

Additionally, in certain embodiments, when two or more solvents are prepared in the production of the nanocomposite composition, each solvent may comprise from 0.1 to 99.9 vol %, alternatively from 1 to 99 vol %, alternatively from 5 to 95 vol %, and alternatively from 10 to 90 vol %, with the total volume of all solvents present at 100 vol %.

In the embodiments described above, the solutions are distinguishable from aqueous solutions or are non-aqueous solutions. Aqueous solutions are solutions where water is either the primary or sole solvent. They have been described in, for example, U.S. Pat. No. 6,087,016 and US 2003-0198767 A1. See also U.S. Pat. No. 5,576,372 (Example 1). However, in certain embodiments, the solutions may contain water. In these embodiments, water is inert in the solution such that it is more akin to a contaminant and does not act as a primary solvent for the solution components, i.e., elastomer, layered filler, etc.

The nanocomposites used to make the innerliners that go into the making of a tire can also be produced by conventional melt mixing. Also, even if the solution method is used to make the nanocomposite composition, melt mixing is typically performed to blend the other components with the nanocomposite to form the innerliner composition. In either case, mixing is performed typically at temperatures equal to or greater than the softening point of the elastomer and/or secondary elastomer or rubber used in the composition; for example, 80° C. up to 300° C. in another embodiment, and from 120° C. to 250° C. in yet another embodiment, under conditions of shear sufficient to allow the clay intercalate to exfoliate and become uniformly dispersed within the polymer to form a nanocomposite. When preparing a composition that is not dynamically-vulcanized, typically, 70% to 100% of the elastomer or elastomers are first mixed for 20 to 90 seconds, or until the temperature reaches 40 to 60° C. Then, the filler, and the remaining amount of elastomer, if any, is typically added to the mixer, and mixing continues until the temperature reaches 90° C. to 150° C. The finished mixture is then sheeted on an open mill and allowed to cool to 60° C. to 100° C. at which time the cure system or curatives are added. Alternatively, the cure system can be mixed in an internal mixer of mixing extruder provided that suitable care is exercised to control the temperature. Mixing with clays is performed by techniques known to those skilled in the art, wherein clay is added to the polymer(s) at the same time as the carbon black in one embodiment. The processing oil is typically added later in the mixing cycle after the carbon black and clay have achieved adequate dispersion in the elastomeric or polymer matrix.

Regardless of how mixed, that is, melt mixing or solution mixing, the compounds of nanocomposites may be prepared using a polymer/clay nanocomposite masterbatch (10× phr MB) that comprises 100 parts of polymer and X parts of clay. For example, the nanocomposite having 8 parts of clay would be used as 108 phr in the compounding formulation, including additives described further below. An example of a useful formulation (in “phr”) for property evaluation would be as follows:

| Material | Example Ranges (phr) | Examples |
|---|---|---|
| Nanocomposite: | | |
| Elastomer | 100 | BIMS |
| Layered clay | 4, 5 to 6, 7, 8 or 10 | montmorillonite |
| Exfoliating agent | 0.1, 0.2, 0.5, 1 to 5, 6, 7 or 8 | tallow ammonium |
| | | salt |
| Carbon Black | 20, 30, 40, 50 to 70, 80 or 90 | N660 |
| Oil | <8, 7, 6, 5 or 4 | Naphthenic |
| Curatives | 0.1, 0.2 to 1, 2, 3, 4 or 5 | stearic acid, ZnO, |
| | | MBTS |

### Additives

The nanocomposites and compositions for innerliners and/or tires disclosed herein typically include other additives customarily used in rubber mixes, such as effective amounts of processing aids, pigments, accelerators, crosslinking and curing materials, antioxidants, antiozonants. General classes of accelerators include amines, diamines, guanidines, thioureas, thiazoles, thiurams, sulfenamides, sulfenimides, thiocarbamates, xanthates, and the like. Crosslinking and curing agents include sulfur, zinc oxide, and fatty acids. Peroxide cure systems may also be used.

The innerliner and tire components described herein may include fillers other than the exfoliated clay. The one or more fillers, in addition to the clay added to the elastomer to form the nanocomposite, may be fillers known in the art such as, for example, calcium carbonate, silica, clay and other silicates which may or may not be exfoliated, talc, titanium dioxide, and carbon black. Silica is meant to refer to any type or particle size silica or another silicic acid derivative, or silicic acid, processed by solution, pyrogenic or the like methods and having a surface area, including untreated, precipitated silica, crystalline silica, colloidal silica, aluminum or calcium silicates, fumed silica, and the like. In particular embodiments, the filler is present within the range from 20 or 30 or 40 or 50 to 70 or 80 or 90 phr.

One or more crosslinking agents, such as a coupling agent, may also be used, especially when silica is also present in the composition. The coupling agent may be a bifunctional organosilane crosslinking agent. An “organosilane crosslinking agent” is any silane coupled filler and/or crosslinking activator and/or silane reinforcing agent known to those skilled in the art including, but not limited to, vinyl triethoxysilane, bis-(3-triethoxysilypropyl)tetrasulfide, vinyl-tris-(beta-methoxyethoxy)silane, methacryloylpropyltrimethoxysilane, gamma-amino-propyl triethoxysilane (sold commercially as A1100 by Witco), gamma-mercaptopropyltrimethoxysilane (A189 by Witco) and the like, and mixtures thereof.

In one embodiment, the additional filler is carbon black or modified carbon black, and combinations of any of these. In another embodiment, the filler may be a blend of carbon black and silica. In a particular embodiment, the filler used in the tire and innerliner components is reinforcing grade carbon black present at a level of from 10 to 100 phr of the blend, more preferably from 30 to 80 phr in another embodiment, and from 50 to 80 phr in yet another embodiment. Useful grades of carbon black, as is well known in the art, range from N110 to N990. More desirably, embodiments of the carbon black useful in, for example, tire treads are N229, N351, N339, N220, N234 and N110 provided in ASTM (D3037, D1510, and D3765). Embodiments of the carbon black useful in, for example, tire sidewalls, are N330, N351, N550, N650, N660, and N762. Carbon blacks suitable for innerliners and other air barriers include N550, N660, N650, N762, N990, and Regal 85.

Generally, polymer blends, for example, those used to produce tires, are crosslinked or “cured”. It is known that the physical properties, performance characteristics, and durability of vulcanized rubber compounds are directly related to the number (crosslink density) and type of crosslinks fanned during the vulcanization reaction. Generally, polymer blends may be crosslinked by adding curative molecules, for example sulfur, metal oxides, organometallic compounds, radical initiators, etc., followed by heating. In particular, the following metal oxides are common curatives that can be useful: ZnO, CaO, MgO, Al₂O₃, CrO₃, FeO, Fe₂O₃, and NiO. These metal oxides can be used alone or in conjunction with the corresponding metal fatty acid complex (e.g., zinc stearate, calcium stearate, etc.), or with the organic and fatty acids added alone, such as stearic acid, and optionally other curatives such as sulfur or a sulfur compound, an alkylperoxide compound, diamines or derivatives thereof (e.g., Diak™ products sold by DuPont). This method of curing elastomers may be accelerated and is often used for the vulcanization of elastomer blends. Such components as the metal oxides and sulfur may be present to within the range of from 0.1 or 0.2 to 1 or 2 or 3 phr, each.

The acceleration of the cure process is accomplished in certain embodiments by adding to the composition an amount of an accelerant. The mechanism for accelerated vulcanization of natural rubber involves complex interactions between the curative, accelerator, activators and polymers. Ideally, all of the available curative is consumed in the formation of effective crosslinks which join together two polymer chains and enhance the overall strength of the polymer matrix. Numerous accelerators are known in the art and include, but are not limited to, the following: stearic acid, diphenyl guanidine (DPG), tetramethylthiuram disulfide (TMTD), 4,4′-dithiodimorpholine (DTDM), tetrabutylthiuram disulfide (TBTD), benzothiazyl disulfide (MBTS), hexamethylene-1,6-bisthiosulfate disodium salt dihydrate (sold commercially as Duralink™ HTS by Flexsys), 2-(morpholinothio) benzothiazole (MBS or MOR), blends of 90% MOR and 10% MBTS (MOR 90), N-tertiarybutyl-2-benzothiazole sulfenamide (TBBS), and N-oxydiethylene thiocarbamyl-N-oxydiethylene sulfonamide (OTOS), zinc 2-ethyl hexanoate (ZEH), and “thioureas”.

Taken together, such agents as accelarants, metal oxides, sulfur and other “curatives” may be present in the compositions described herein within the range of from 0.1 or 0.2 to 1 or 2 or 3 or 4 or 5 phr.

In other embodiments, desirable elastomer impermeability is achieved by the presence of at least one polyfunctional curative. An embodiment of such polyfunctional curatives can be described by the formula Z—R⁷—Z′, wherein R⁷ is one of a C₁ to C₁₅ alkyl, C₂ to C₁₅ alkenyl, and C₆ to C₁₂ cyclic aromatic moiety, substituted or unsubstituted; and Z and Z′ are the same or different and are one of a thiosulfate group, mercapto group, aldehyde group, carboxylic acid group, peroxide group, alkenyl group, or other similar group that is capable of crosslinking, either intermolecularly or intramolecularly, one or more strands of a polymer having reactive groups such as unsaturation. So called bis-thiosulfate compounds are an example of a class of polyfunctional compounds included in the above formula. Non-limiting examples of such polyfunctional curatives are as hexamethylene bis(sodium thiosulfate) and hexamethylene bis(cinnamaldehyde), and others are well known in the rubber compounding arts. These and other suitable agents are well known in the art. The polyfunctional curative, if present, may be present in the nanocomposite from 0.1 to 8 phr in one embodiment, and from 0.2 to 5 phr in yet another embodiment.

Phenol formaldehyde resins (or “phenolic resins”) are used as a curative in certain embodiments. In one embodiment, only one type of phenol formaldehyde resin is used, in another embodiment a mixture of two or more types of phenyl formaldehyde resins is sued. In one embodiment, the phenol formaldehyde resin is selected from the group consisting of structures (3):

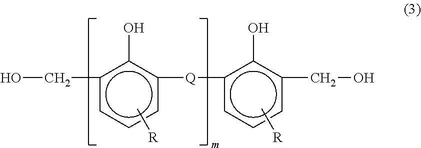

wherein m ranges from 1 to 50, more preferably from 2 to 10; R is selected from the group consisting of hydrogen and C1 to C20 alkyls in one embodiment; and is selected from the group consisting of C4 to C14 branched alkyls in a particular embodiment; and Q is a divalent radical selected from the group consisting of —CH₂—, and —CH₂—O—CH₂—.

In certain embodiments, the phenol formaldehyde resin is halogenated, and in yet other embodiments, a mixture of halogenated and non-halogenated phenol formaldehyde resin is used. Also, the phenol formaldehyde resin may be in any form such as a solid, liquid, solution or suspension. Suitable solvents or diluents include liquid alkanes (e.g., pentane, hexane, heptane, octane, cyclohexane), toluene and other aromatic solvents, paraffinic oils, polyolefinic oils, mineral oils, or silicon oils, and blends thereof. In certain embodiments, the compositions, innerliner and/or tires described herein may comprise within the range from 1 or 2 or 3 to 6 or 8 or 10 or 12 phr of at least one phenolic resin.

A processing aid, or “oil,” may also be included. Processing aids include, but are not limited to, plasticizers, extenders, chemical conditioners, homogenizing agents and peptizers such as mercaptans, petroleum and vulcanized vegetable oils, mineral oils, parraffinic oils, polybutene polymers, naphthenic oils, aromatic oils, waxes, resins, rosins, and the like. The processing aid, in an aggregate amount if two or more processing aids are present together, is present from less than 8 or 7 or 6 or 5 or 4 phr in certain embodiments, or within the range from 0.1 or 0.5 or 1 or 2 or 3 or 4 to 6 or 8 phr, in an aggregate amount if two or more processing aids are present together, in other embodiments.

Some commercial examples of processing aids are Sundex™ (Sun Chemicals), a naphthenic processing aid, polybutene processing oil having a number average molecular weight of from 800 to 5000 amu, and Flexon™ (ExxonMobil Chemical Company), a paraffinic petroleum oil. In one embodiment, paraffinic, naphthenic and aromatic oils are substantially absent, meaning, they have not been deliberately added to the compositions used to make the air barriers, or, in the alternative, if present, are only present up to 0.2 wt % of the compositions used to make the air barriers. In another embodiment of compositions, naphthenic and aromatic oils are substantially absent. Commercial examples of these include, for example, Flexon oils (which contain some aromatic moieties) and Calsol™ oils (naphthenic oil).

In another embodiment, other additives can be present such as tackifiers and polymers such as plastomers and thermoplastics. Useful plastomers comprise ethylene derived units and from 10 wt % to 30 wt % of C₃ to C₁₀ α-olefin derived units. In another embodiment, the plastomer comprises ethylene derived units and from 10 wt % to 30 wt % of units selected from 1-butene, 1-hexene and 1-octene derived units. In yet another embodiment, the plastomer comprises ethylene derived units and from 10 wt % to 30 wt % of octene derived units. In an embodiment, the plastomer has a melt index of from 0.1 to 20 dg/min, and from 0.1 to 10 dg/min in another embodiment. Examples of commercially available plastomers are Exact™ 4150, a copolymer of ethylene and 1-hexene, the 1-hexene derived units making up from 18 to 22 wt % of the plastomer and having a density of 0.895 g/cm³ and melt index (2.16/190) of 3.5 dg/min (ExxonMobil Chemical Company, Houston, Tex.); and Exact 8201, a copolymer of ethylene and 1-octene, the 1-octene derived units making up from 26 to 30 wt % of the plastomer, and having a density of 0.882 g/cm³ and melt index (2.16/190) of 1.0 dg/min (ExxonMobil Chemical Company, Houston, Tex.).

In certain embodiments, tackifiers may be present in the innerliners and/or tire components, and may also be referred to in the art as hydrocarbon resins, include low molecular weight amorphous, thermoplastic polymers derived from synthetic or natural monomers. These monomers include those derived from petroleum resins including trans-piperylene, aromatics such as styrene, 2-methyl-2-butene; terpene resins including limonene, and β-pinene; rosins such as abietic acid; and various cyclodienes. The resins may be hydrogenated. A commercial example of a tackifier is Struktol™ hydrocarbon resins (Struktol Company of America). In certain embodiments, the tackifier or plastomer is present in the innerliner compositions within the range from 2 or 3 or 4 or 5 to 8 or 10 or 12 or 15 phr.

### Producing the Innerliner and Pneumatic Tire

The compositions of the described herein and layered structures formed using such compositions can be used in pneumatic tire applications; tire curing bladders; air sleeves, such as air shock absorbers, diaphragms; and hose applications, including gas and fluid transporting hoses. The compositions and tie layer comprising such compositions are particularly useful in pneumatic tires to facilitate the adhesion and air holding qualities of a tire innerliner to the inner surface of the tire. An especially useful construction is one in which a tire innerliner layer forms the innermost surface of the tire and the innerliner layer surface opposite the one that forms the air holding chamber is in contact with the tie layer. Alternatively, an adhesive layer can be used between the innerliner layer and the tie layer. The surface of the tie layer opposite the one that is in contact with the innerliner (or adhesive layer) is in contact with the tire layer referred to as the carcass; in other words, the tire layer typically comprising reinforcing tire cords. The innerliner layer exhibits advantageously low permeability properties and preferably comprises the nanocomposite.

Furthermore, as a consequence of the unique composition of the innerliner, in particular its low air permeability property, allows for the use of a thin innerliner compared to compositions containing primarily high diene rubber. The resulting overall structure based on such innerliner allows for a tire construction (as well as other constructions comprising an air or fluid holding layer and tie layer) having reduced weight. Such weight savings in a tire construction are significant, especially in very large tires having an overall diameter (tread to tread) of greater than 17.5 or 20 or 25 or 30 or 40 or 55 inches, and optionally, a section width of at least 10 or 11 or 12 or 14 inches. The large tires may also be characterized in certain embodiments by having a long cure time; that is, wherein the green tire is of a size that requires a cure time of greater than 30 minutes or 1 hour or 5 hours or 10 hours or 16 hours. Such tires include truck tires, airplane tires, off-the-road tires and farm tractor tires.

Naturally, adjustment of the concentration and type of halogenated elastomer in the tie layer, compositional adjustments in the innerliner layer and selection of the thickness of each of these layers can result in different weight savings. Typically, the air holding (or fluid holding in the case of applications other than tires) characteristics determine choice of such variables and limited experimentation can be used by the compounder and/or designer to assist in making such decisions. However, typically 2% to 16% weight savings can be realized; alternatively, 4% to 13% weight savings. Such improvements are particularly meaningful in an application such as pneumatic tires.

The tire innerliner composition (i.e., the nanocomposite and additional components) may be prepared by using conventional mixing techniques including, e.g., kneading, roller milling, extruder mixing, internal mixing (such as with a Banbury® mixer) etc. The sequence of mixing and temperatures employed are well known to the rubber compounder of ordinary skill in the art, the objective being the dispersion of fillers, activators and curatives in the polymer matrix under controlled conditions of temperature that will vary depending on the nature of the nanocomposite. For preparation of an innerliner based on non-DVA (Dynamically Vulcanized Alloy) technology, a useful mixing procedure utilizes a Banbury mixer in which the copolymer rubber, carbon black and plasticizer are added and the composition mixed for the desired time or to a particular temperature to achieve adequate dispersion of the ingredients. Alternatively, the rubber and a portion of the carbon black (e.g., one-third to two thirds) are mixed for a short time (e.g., 1 to 3 minutes) followed by the remainder of the carbon black and oil. Mixing is continued for 5 to 10 minutes at high rotor speed during which time the mixed components reach a temperature of 140° C. Following cooling, the components are mixed in a second step, e.g., on a rubber mill or in a Banbury mixer, during which the cure system, e.g., curing agent and optional accelerators, are thoroughly and uniformly dispersed at relatively low temperature, e.g., 80 to 105° C., to avoid premature curing or “scorching” of the composition. Variations in mixing will be readily apparent to those skilled in the art this disclosure is not limited to any specific mixing procedure. The mixing is performed to disperse all components of the composition thoroughly and uniformly.

The innerliner layer or “stock” is then prepared by calendering the compounded rubber composition into sheet material having a thickness of 0.5 mm to 2 mm and cutting the sheet material into strips of appropriate width and length for innerliner application in a particular size or type tire. The innerliner is then ready for use as an element in the construction of a pneumatic tire. The pneumatic tire is typically comprised of a multilayered laminate comprising an outer surface which includes the tread and sidewall elements, an intermediate carcass layer which comprises a number of plies containing tire reinforcing fibers, (e.g., rayon, polyester, nylon or metal fibers) embedded in a rubbery matrix, a tie layer as described herein, an optional adhesive layer, and an innerliner layer. Tires are normally built on a tire forming drum using the layers described above. After the uncured tire has been built on the drum, it is removed and placed in a heated mold.

The mold contains an inflatable tire shaping bladder that is situated within the inner circumference of the uncured tire. After the mold is closed the bladder is inflated and it shapes the tire by forcing it against the inner surfaces of the closed mold during the early stages of the curing process. The heat within the bladder and mold raises the temperature of the tire to vulcanization temperatures. Vulcanization temperatures are typically 100° C. to 250° C.; preferably 150° C. to 200° C. Cure time may vary from 30 minutes to several hours for the tires described herein. Cure time and temperature depend on many variables well known in the art, including the composition of the tire components, including the cure systems in each of the layers, the overall tire size and thickness, etc.

Vulcanization parameters can be established with the assistance of various well-known laboratory test methods, including the test procedure described in ASTM D2084-01, (Standard Test Method for Rubber Property-Vulcanization Using Oscillating Disk Cure Meter) as well as stress-strain testing, adhesion testing, flex testing, etc. Vulcanization of the assembled tire results in complete or substantially complete vulcanization (or “crosslinking”, “curing”) of all elements or layers of the tire assembly, i.e., the innerliner, the carcass and the outer tread and sidewall layers. In addition to developing the desired strength characteristics of each layer and the overall structure, vulcanization enhances adhesion between these elements, resulting in a cured, unitary tire from what were separate, multiple layers.

In certain embodiments, the nanocomposite compositions and innerliners made using the nanocomposite compositions described herein, and tires made therefrom, possess a permeation coefficient of less than 200 or 180 or 160 or 140 mm·cm³/[m²·day] at 40° C.

Furthermore, in certain embodiments the tires described herein have an Endurance value of at least 90 or 100 hours-to-failure. Also, in certain embodiments the tires described herein have a Durability value of at least 240 or 250 hours-to-failure. And furthermore, the tires described herein have a reversion resistance of the tire does not decline by more than 5% from its maximum Torque value at Tₘₐₓ₋₁₀ at 180° C. The “Tₘₐₓ₋₁₀” is the time that is 10 minutes after the torque reaches its maximum value. Preferably, the reversion resistance is constant after reaching its maximum value.

### EXAMPLES

Endurance Test. The endurance test was conducted as described in Federal Motor Vehicle Safety Standard FMVSS 119, but where the tires were run to failure. Testing was done on a 1.701 meter diameter (67″ diameter) dynamometer. Tires were mounted on a rim and inflated to their maximum inflation pressure, 123 psi, at the maximum single rated load (7165 lbs) as defined in the Tire and Rim Association Yearbook. The dynamometer was started so the tire ran, under load, at a steady speed of 30 mph. The initial applied load of 70% of the rated load was then increased in 10% increments of the standard 7165 lbs maximum load, in 8 hour intervals. Tires were run to failure manifested as either rapid air loss or center crown and belt separation. Temperatures were measured at 8 hour intervals by using a needle probe and measuring the temperature in the center line of the tread and both shoulder regions.

Durability Test. The durability test was conducted following the principles described in Federal Motor Vehicle Safety Standard FMVSS 119, but where the tires were testing on a 120″ diameter dynamometer and were also run to failure. Tires were mounted on a rim and inflated to their maximum inflation pressure, 123 psi, at the maximum single rated load (7165 lbs) as defined in the Tire and Rim Associate Yearbook. The dynamometer was started so the tire ran, under load, at a steady speed of 50 mph. The initial applied load of 90% of the rated load was then increased in 10% increments of the standard 7165 lbs maximum load, at mileage intervals as follows:

| i. | 80% rated load | 1000 miles |
|---|---|---|
| ii. | 90% | 1000 |
| iii. | 100% | 2000 |
| iv. | 110% | 2000 |
| v. | 120% | 2000 |
| vi. | 130% | 2000 |
| vii. | 140% | Run to failure |

Temperature was measured at each load step increase. Temperature at tread centerline and each shoulder was reported for 4 separate points around the tire circumference and averaged. Temperatures were measured using a needle probe.

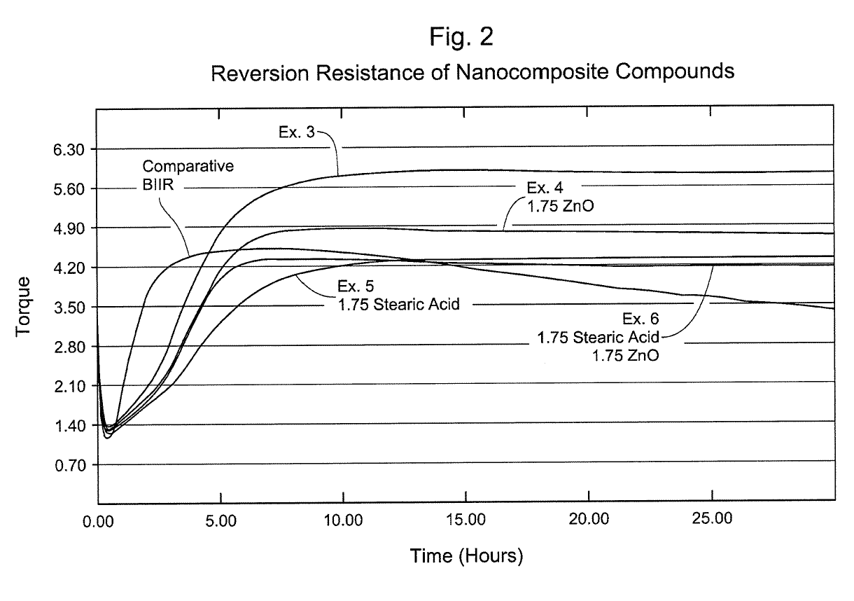

Reversion Resistance. In this instance reversion resistance is a visual conclusion from FIG. 2. Briefly, the compound cure kinetics is measured using a moving die rheometer (MDR) as described in ASTM D5289. Five compounds whose formulations are tabulated in Table VII were tested using the MDR rheometer and a plot of the cure profile is presented in FIG. 3. It can be seen that of the four nanocomposite formulations, two which contain higher levels of stearic acid and the vulcanization accelerator, MBTS, show a flat maximum cure profile or reach a steady state plateau. The levels of MBTS and stearic acid were set according to a 2×2 factorial design. However the control bromobutyl compound, upon reaching a maximum state of cure then goes into a decline or reversion, this being clearly evident in FIG. 2.

Permeability. Permeability testing proceeded according to the following description. All examples were compression molded with slow cooling to provide defect free pads. A compression and curing press was used for rubber samples. Typical thickness of a compression molded pad is around 0.38 mm using an Arbor press, 2″ diameter disks were then punched out from molded pads for permeability testing. These disks were conditioned in a vacuum oven at 60° C. overnight prior to the measurement. The oxygen permeation measurements were done using a Mocon OX-TRAN 2/61 permeability tester at 40° C. under the principle of R. A. Pasternak et. al. in 8 JOURNAL OF POLYMER SCIENCE: PART A-2 467 (1970). Disks thus prepared were mounted on a template and sealed with vacuum grease. A steady flow of oxygen at 10 mL/min was maintained on one side of the disk, while a steady flow of nitrogen at 10 mL/min was maintained on the other side of the disk. Using the oxygen sensor on the nitrogen side, increase in oxygen concentration on the nitrogen side with time could be monitored. The time required for oxygen to permeate through the disk, or for oxygen concentration on the nitrogen side to reach a constant value, is recorded and used to determine the oxygen gas permeability.

Other Test Methods. The values “MH” and “ML” used here and throughout the description refer to “maximum torque” and “minimum torque”, respectively. The “MS” value is the Mooney scorch value, the “ML(1+4)” value is the Mooney viscosity value. Mooney and scorch time was measured by ASTM D1646 (modified). The error (2σ) in the later measurement is ±0.65 Mooney viscosity units. The values of “Tc” are cure times in minutes “c”, and “Ts” is scorch time”. Tensile and Modulus was measured by ASTM D412.

Dynamic properties (G*, G′, G″ and tangent delta) were determined using a MTS 831 mechanical spectrometer for pure shear specimens (double lap shear geometry) at temperatures of −20° C., 0° C. and 60° C. using a 1 Hz frequency at 0.1, 2 and 10% strains. Temperature-dependent (−80° C. to 60° C.) dynamic properties were obtained using a Rheometrics ARES at Sid Richardson Carbon Company, Fort Worth, Tex. and at ExxonMobil Chemical, Baytown, Tex. A rectangular torsion sample geometry was tested at 1 Hz and appropriate strain. Values of G″ or tangent delta measured at 0° C. in laboratory dynamic testing can be used as predictors of tire traction for carbon black-filled BR/sSBR (styrene-butadiene rubber) compounds. Temperature-dependent (−90° C. to 60° C.) high-frequency acoustic measurements were performed at Sid Richardson Carbon Company using a frequency of 1 MHz and ethanol as the fluid medium.

### Preparation of Examples

The nanocomposites demonstrated herein are produced by a continuous process, which includes the mixing of a brominated poly(isobutylene-co-p-methylstyrene) (“BIMS”, (10 wt % para-methylstyrene and 0.8 mole % bromine, both by weight and mole of the elastomer)) solution and clay slurry within two contacting vessels, followed by precipitation of the clay containing polymer in water, and final drying of the material by a series of extrusion steps. This elastomer was made by techniques known in the art and disclosed at, for example, U.S. Pat. No. 5,162,445. Such polymers are available from ExxonMobil Chemical Co. and known as “Exxpro™” elastomers. In these Examples, the exfoliated clay was purchased and used as is from Southern Clay Products as Cloisite™ 20A; the exfoliating agent was dimethyl dehydrogenated tallow quaternary ammonium chloride salt and the clay was a montmorillonite clay, the exfoliated clay having a 50% particle size distribution of less than 6 μm.

The BIMS solution was produced either by re-dissolving baled material in a suitable hydrocarbon solvent such as hexane, cyclohexane, or toluene, or, preferably, recovered from polymer cement taken from the manufacturing process just subsequent to bromination. Typical polymer solution concentrations are 20-25% by weight. The clay slurry was prepared by mixing the clay with the same hydrocarbon solvent used to prepare the polymer solution. This mixing was conducted via multiple batches in a vessel that was equipped with an agitator that uniformly disperses the clay in the solvent. The slurry was then transferred to a larger surge where it was continuously stirred to inhibit settling of the clay particles, and removed for mixing with the polymer solution. Typical clay concentrations were 5-7 wt % by weight of the clay-BIMS blend.

Mixing of the polymer solution and organically modified clay was conducted within different sized vessels that were connected in series and equipped with agitators that supply ample mixing to blend the polymer solution and clay slurry. Precipitation of the polymer was completed within two vessels that are connected in series with a recycle loop. Each vessel was equipped with individual temperature and pressure control, which combined with the recycle loop enables near complete removal of the solvent from the clay/polymer mixture. Both vessels were also equipped with agitators to aid in controlling the particle size of the precipitated mixture of elastomer and clay. During operation approximately 5% of the recycle stream between the re-slurry vessels was diverted for de-watering and drying. This process consisted of passing the clay/polymer slurry over a de-watering screen, which was then fed to a de-watering extruder (i.e. a single screw extruder that was equipped with vented barrels). The material that exits this extruder was then fed into a series of two tangential twin-screw extruders, which dries the polymer clay mixture to water contents that are less than about 0.1% by weight. The stranded material that exits the final extruder was then cut by hand and packaged in high-density polyethylene release film, prior to storage a drum.

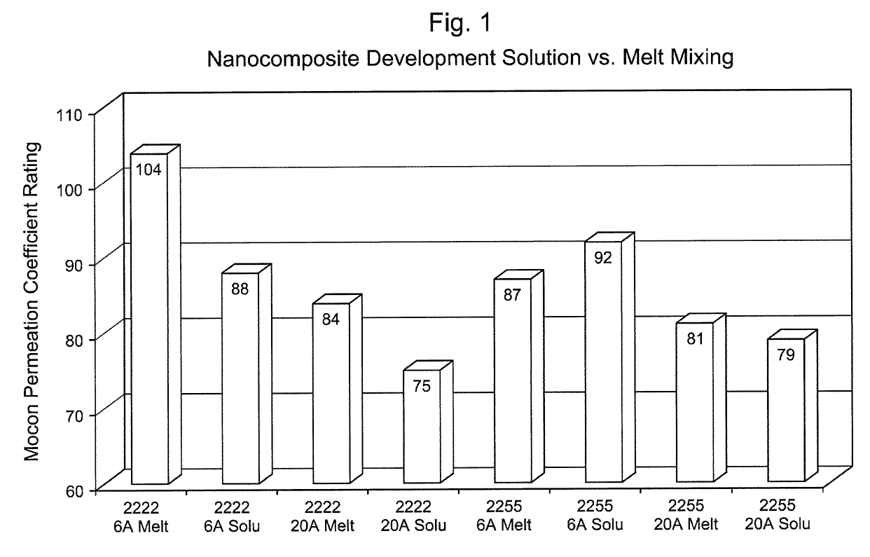

Preparation of a nanocomposite by this method is superior to that prepared by more conventional melt mixing. FIG. 1 graphically shows the better impermeability performance obtained by the solution process for various exfoliated clay-elastomer nanocomposites, where “2222” and “2225” is ExxonMobil Bromobutyl 2222 and ExxonMobil Bromobutyl 2225, respectively, and “6A” and “20A” is Cloisite 6A and Cloisite 20A from Southern Clay Products, respectively.

Table 1 illustrates a compound formula containing a nanocomposite prepared by the solution process. Comparative example 1 is considered to be a representative innerliner formula suitable or use in large off road tires using bromobutyl rubber (“BIIR 2222” is ExxonMobil Bromobutyl 2222). Example 2 is a model innerliner compound containing a BIMS (10 wt % para-methylstyrene and 0.8 mole % bromine, both by weight and mole of the elastomer) and Cloisite 20A (3.8 phr exfoliating agent and 10 phr Cloisite 20A overall) plus other necessary compounding materials such as carbon black, process aids, and the vulcanization system. The “phenolic resin” is obtained from Schenectady International, Inc. In all cases, the nanocomposites and bromobutyl rubber are blended with the additional components in a Banbury melt mixer in a conventional manner. The other ingredients are obtained from conventional suppliers known in the art.

Table 2 illustrates typical properties that can be achieved using nanocomposites compounds described in Table 1. It is seen that Mooney viscosity of the reference compound containing bromobutyl and the nanocomposite compound are equivalent, and classical mechanical properties such as tensile strength and modulus at 300% elongation are equivalent.

TABLE 1
Nanocomposite Compositions

| | Comparative | |
|---|---|---|
| Component | Example 1 | Example 2 |
| BIIR 2222 | 100.0 | — |
| BIMS-exfoliated clay | — | 110 |
| Carbon black N660 | 60.0 | 60.0 |
| Naphthenic oil | 8.0 | 3.5 |
| Strucktol 40 MS | 7.0 | 7.0 |
| Phenolic Resin SP-1068 | 4.0 | 4.0 |
| Stearic acid | 1.0 | 1.0 |
| ZnO | 1.0 | 1.0 |
| MBTS | 1.25 | 1.25 |
| Sulfur | 0.50 | 0.50 |
| Total phr | 182.75 | 188.25 |

TABLE 2
Properties of the Example Innerliner

| | Comparative | |
|---|---|---|
| Property | Example 1 | Example 2 |
| Mooney Viscosity, ML (1 + 4) | 57 | 61 |
| Mooney Minimum, ML (1 + 4) | 23 | 15 |
| T₅ (min) | 26 | 15 |
| Tensile strength, MPa | 9.4 | 9.0 |
| Elongation, % | 864 | 889 |
| 300% Modulus, MPa | 2.8 | 3.7 |
| Permeation coefficient, | 204 | 133 |
| mm · cm³/m² · day | | |
| at 40° C. | | |
| Loss Modulus G″ (MPa) | 0.975 | 2.049 |

For illustrative purposes only, radial medium truck tires were constructed with a compound similar to that used for the compositions in Table 2. The specific size of tire was a 275/80R22.5 LR-H. The performance obtained by use of a nanocomposite innerliner is illustrated in Table 3. Compared to the reference bromobutyl innerliner compound, improvements are noted in durability and air retention (IPR). At 47 hours running on a 67 inch diameter dynamometer, it was also noted that the nanocomposite tire operating temperature was cooler than the reference bromobutyl innerliner compound tire.

TABLE 3
Nanocomposite Tire Performance

| | | |
|---|---|---|
| | Tire made from | |
| | Comparative | Tire made from |
| | Example 1 | Example 2 |
| Property | innerliner¹ | innerliner² |

Endurance

| | | |
|---|---|---|
| miles-to-failure | 2650 | 3261 |
| hours-to-failure | 87.1 | 108.7 |

Durability

| | | |
|---|---|---|
| miles-to-failure | 9500 | 10,500 |
| hours-to-failure | 237 | 262 |

Inflation Pressure Retention

| | | |
|---|---|---|
| Test 1 | 0.336 | 0.263 |
| Test 2 | 1.120 | 0.410 |
| Temperature at 47 hours, | 156 (69) | 132 (56) |
| ° F. (° C.) | | |

¹The innerliner is 2.3-1.4 mm thick.
²The innerliner is 1.6-1.5 mm thick.

Large tires such as off-the-road and airplane tires require long cure or vulcanization periods. For example a 40.00R57 size dump truck tire requires cure times form 16 to 24 hours. A 18.00R24 size grader tire will require 4 to 8 hours of cure time. Therefore the innerliner must display adequate reversion resistance. Five compounds were prepared and MDR rheometer tests run at 180° C. to determine the reversion resistance of the nanocomposite compounds. The compounds are illustrated in Table 4.

TABLE 4
Sample compound reversion resistance

| | Compar- | Exam- | Exam- | Exam- | Exam- |
|---|---|---|---|---|---|
| Component | ative 1 | ple 3 | ple 4 | ple 5 | ple 6 |
| BIIR 2222 | 100.0 | — | — | — | — |
| BIMS-exfoliated clay | — | 100.0 | 100.0 | 100.0 | 100.0 |
| Carbon black N660 | 60.0 | 60.0 | 60.0 | 60.0 | 60.0 |
| Naphthenic oil | 8.0 | 3.5 | 3.5 | 3.5 | 3.5 |
| Strucktol 40 MS | 7.0 | 7.0 | 7.0 | 7.0 | 7.0 |
| Phenolic Resin SP- | 4.0 | 4.0 | 4.0 | 4.0 | 4.0 |
| 1068 | | | | | |
| Stearic acid | 1.0 | 1.0 | 1.75 | 1.0 | 1.75 |
| ZnO | 1.0 | 1.00 | 1.0 | 1.00 | 1.00 |
| MBTS | 1.25 | 1.25 | 1.25 | 1.75 | 1.75 |
| Sulfur | 0.50 | 0.50 | 0.50 | 0.50 | 0.50 |

Having elucidated the various features of the innerliners and tires described herein, described further in numbered embodiments is:
1. A pneumatic tire comprising an innerliner comprising (or consisting essentially of):
   a functionalized poly(isobutylene-co-p-methylstyrene) elastomer, at least one layered filler; and
   less than 8 or 7 or 6 or 5 or 4 phr (or within the range from 0.1 or 0.5 or 1 or 2 or 3 or 4 to 6 or 8 phr) of at least one processing aid;
   wherein the innerliner possesses a permeation coefficient of less than 200 or 180 or 160 mm·cm³/m²·day at 40° C.; and
   wherein the tire is selected from truck tires, airplane tires, off-road tires and farm tractor tires.
2. The tire of numbered embodiment 1, wherein the functionalized poly(isobutylene-co-p-methylstyrene) elastomer has a Mooney Viscosity (ML1+4) of less than 50 or 45 or 40.
3. The tire of numbered embodiments 1 and 2, wherein the functionalized poly(isobutylene-co-p-methylstyrene) elastomer has a p-methylstyrene-derived content within the range from 4 or 5 or 6 to 9 or 11 or 13 or 15 or 17 wt %, by weight of the elastomer.
4. The tire of any one of the previously numbered embodiments, wherein the amount of the at least one layered filler is within the range from 4 or 5 phr to 6 or 7 or 8 or 10 phr.
5. The tire of any one of the previously numbered embodiments, wherein the layered filler also comprises an exfoliating agent.
6. The tire of claim 5, wherein the exfoliating agent has a weight average molecular weight of less than 5000 or 2000 or 1000 or 800 or 500 or 400 amu (and within the range from 200 or 300 to 400 or 500 or 800 or 1000 or 2000 or 5000 amu).
7. The tire of claim 5, wherein the exfoliating agent is present within the range from 5 or 10 or 15 or 20 to 40 or 45 or 50 or 55 or 60 wt %, based on the weight of exfoliating agent and elastomer.
8. The tire of any one of the previously numbered embodiments, wherein the tire is formed by the process of contacting the functionalized poly(isobutylene-co-p-methylstyrene) elastomer, at least one layered filler, and at least one solvent to form a nanocomposite composition; and combining the nanocomposite composition with less than 8 or 7 or 6 or 5 or 4 phr of at least one processing aid and a curative composition to form an innerliner composition, the tire formed to comprise an innerliner formed from the innerliner composition.
9. The tire of numbered embodiment 8, wherein the solvent is removed from the nanocomposite composition prior to combining with the at least one process oil and curative composition.
10. The tire of any one of the previously numbered embodiments, wherein the tire is produced by melt blending all of the components to form an innerliner composition, the tire formed to comprise an innerliner formed from the innerliner composition.
11. The tire of any one of the previously numbered embodiments, wherein the layered filler has an aspect ratio of greater than 30 or 40 or 50 or 60, or within the range from 30 or 40 or 50 to 90 or 100 or 120 or 140.
12. The tire of any one of the previously numbered embodiments, further comprising within the range from 1 or 2 or 3 to 6 or 8 or 10 or 12 phr of at least one phenolic resin.
13. The tire of any one of the previously numbered embodiments, further comprising within the range from 2 or 3 or 4 or 5 to 8 or 10 or 12 or 15 phr of at least one hydrocarbon tackifier.
14. The tire of any one of the previously numbered embodiments, further comprising within the range from 20 or 30 or 40 or 50 to 70 or 80 or 90 phr of carbon black.
15. The tire consistent essentially of any one or more of the previously numbered embodiments. Here, “consisting essentially of” means that no other components are added to the tire that will negatively alter its permeability.
16. A radial pneumatic tire comprising an innerliner consisting essentially of:
   a functionalized poly(isobutylene-co-p-methylstyrene) elastomer possessing a p-methylstyrene-derived content within the range from 4 or 5 or 6 to 9 or 11 or 13 or 15 or 17 wt %, by weight of the elastomer, the functionalized poly(isobutylene-co-p-methylstyrene) elastomer possessing a Mooney Viscosity (ML1+4) of less than 50 or 45 or 40;
   within the range from 5 or 6 or 7 or 8 to 15 or 18 or 20 or 25 phr of at least one layered filler;
   less than 8 or 7 or 6 or 5 or 4 phr (or within the range from 0.5 or 1 or 2 or 3 or 4 to 8 phr) of at least one processing aid;
   within the range from 5 or 10 or 15 or 20 to 40 or 45 or 50 or 55 or 60 wt %, based on the weight of exfoliating agent and elastomer, of a exfoliating agent possessing a weight average molecular weight of less than 5000 or 2000 or 1000 or 800 or 500 or 400 amu (and within the range from 200 or 300 to 400 or 500 or 800 or 1000 or 2000 or 5000 amu);
   within the range from 2 or 3 or 4 or 5 to 8 or 10 or 12 or 15 phr of hydrocarbon tackifier;
   within the range from 20 or 30 or 40 or 50 to 70 or 80 or 90 phr of carbon black;
   within the range from 1 or 2 or 3 to 6 or 8 or 10 or 12 phr of at least one phenolic resin;
   within the range from 0.25 or 0.5 or 0.8 to 3 or 4 or 5 phr of at least one metal oxide or metal carboxylate;
   within the range from 0.25 or 0.50 or 1.0 to 2.0 or 3.0 or 5.0 phr of a curative composition; and
   wherein the components are present in an amount necessary to provide an innerliner possesses a permeation coefficient of less than 200 or 180 or 160 mm·cm³/m²·day at 40° C.
17. The tire of any one of the previously numbered embodiments, wherein the green (uncured) tire is of a size that requires a cure time of greater than 30 minutes or 1 hour or 5 hours or 10 hours or 16 hours.
18. The tire of any one of the previously numbered embodiments, wherein the tire has an Endurance value of at least 90 or 100 hours-to-failure.
19. The tire of any one of the previously numbered embodiments, wherein the tire has a Durability value of at least 240 or 250 hours-to-failure.
20. The tire of any one of the previously numbered embodiments, the reversion resistance of the tire does not decline by more than 5% from its maximum value at Tₘₐₓ₋₁₀ at 180° C.
21. The tire of any one of the previously numbered embodiments, wherein the tire has an overall diameter (tread to tread) of greater than 17.5 or 20 or 25 or 30 or 40 or 55 inches, and in certain embodiments, a section width of at least 10 or 11 or 12 or 14 inches.

What is claimed is:

1. A pneumatic tire comprising an innerliner comprising:
a functionalized poly(isobutylene-co-p-methylstyrene) elastomer, at least one layered filler; and
less than 8 phr of at least one processing aid, wherein the innerliner possesses a permeation coefficient of less than 200 mm·cm³/m²·day at 40° C.; and
wherein the tire is selected from truck tires, airplane tires, off-road tires and farm tractor tires.

2. The tire of claim 1, wherein the functionalized poly(isobutylene-co-p-methylstyrene) elastomer has a Mooney Viscosity (ML1+4) of less than 50 MU.

3. The tire of claim 1, wherein the functionalized poly(isobutylene-co-p-methylstyrene) elastomer has a p-methylstyrene-derived content within the range from 4 to 17 wt %, by weight of the elastomer.

4. The tire of claim 1, wherein the layered filler also comprises an exfoliating agent.

5. The tire of claim 1, wherein the tire is formed by the process of contacting the functionalized poly(isobutylene-co-p-methylstyrene) elastomer, at least one layered filler, and at least one solvent to form a nanocomposite composition; and combining the nanocomposite composition with the at least one processing aid and a curative composition to form an innerliner composition, the tire formed to comprise an innerliner formed from the innerliner composition.

6. The tire of claim 5, wherein the solvent is removed from the nanocomposite composition prior to combining with the at least one process oil and curative composition.

7. The tie of claim 1, wherein the tire is produced by melt blending all of the components to form an innerliner composition, the tire formed to comprise an innerliner formed from the innerliner composition.

8. The tire of claim 1, further comprising within the range from 20 to 90 phr of carbon black.

9. The tire of claim 1, wherein the green tire is of a size that requires a cure time of greater than 30 minutes.

10. The tire of claim 1, wherein the tire has an Endurance value of at least 90 hours-to-failure.

11. The tire of claim 1, wherein the tire has a Durability value of at least 240 hours-to-failure.

12. The tire of claim 1, the reversion resistance of the tire does not decline by more than 5% from its maximum value at Tₘₐₓ₋₁₀ at 180° C.

13. A radial pneumatic tire comprising an innerliner consisting essentially of:
a functionalized poly(isobutylene-co-p-methylstyrene) elastomer possessing a p-methylstyrene-derived content within the range from 4 to 17 wt %, by weight of the elastomer, the functionalized poly(isobutylene-co-p-methylstyrene) elastomer possessing a Mooney Viscosity (ML1+4) of less than 50;
within the range from 5 to 25 phr of at least one layered filler;
less than 8 phr of at least one processing aid;
within the range from 5 to 60 wt %, based on the weight of exfoliating agent and elastomer, of a exfoliating agent possessing a weight average molecular weight of less than 5000 amu;
within the range from 2 to 15 phr of hydrocarbon tackifier;
within the range from 20 to 90 phr of carbon black;
within the range from 1 to 12 phr of at least one phenolic resin;
within the range from 0.25 to 5 phr of at least one metal oxide or metal carboxylate;
within the range from 0.25 to 5.0 phr of a curative composition; and
wherein the components are present in an amount necessary to provide an innerliner possesses a permeation coefficient of less than 200 mm·cm³/[m²·day] at 40° C.

14. The tire of claim 13, wherein the green tire requires a cure time of greater than 30 minutes.

15. The tire of claim 13, wherein the radial tire is selected from truck tires, airplane tires, off-road tires and farm tractor tires.

16. The tire of claim 13, wherein the tire has an overall diameter (tread to tread) of greater than 17.5 inches.
